(19) United States
(12) Patent Application Publication
(10) Pub. No.: US 2021/0065227 A1
(43) Pub. Date: Mar. 4, 2021

(54) INFORMATION PROCESSING METHOD AND INFORMATION PROCESSING APPARATUS

(71) Applicant: Toyota Jidosha Kabushiki Kaisha, Toyota-shi Aichi-ken (JP)

(72) Inventors: Daiki Kaneichi, Nisshin-shi (JP); Takahiro Shiga, Chiryu-shi (JP)

(21) Appl. No.: 17/007,439

(22) Filed: Aug. 31, 2020

(30) Foreign Application Priority Data
Sep. 3, 2019 (JP) 2019-160447

(51) Int. Cl. G06Q 30/02; G06N 20/00; G06K 9/62

(52) U.S. Cl. CPC G06Q 30/0206; G06K 9/6262; G06N 20/00; G06Q 30/0283

(57) ABSTRACT

An information processing method for evaluating teacher data used in a system that forecasts demand for a service by using a forecasting model by machine learning, the method comprises a forecast step of generating demand forecasting data in a second service different from a first service by using the forecasting model that has performed learning by use of first track record data in the first service as teacher data; and a calculation step of calculating a degree of contribution of the first track record data in demand forecasting for the second service based on the result of a comparison made between the demand forecasting data and second track record data in the second service.

### CROSS REFERENCE TO RELATED APPLICATION

This application claims the benefit of Japanese Patent Application No. 2019-160447 filed on Sep. 3, 2019 which is hereby incorporated by reference herein in its entirety.

### BACKGROUND

### Technical Field

The present disclosure relates to a technology to perform the forecasting of demand.

### Description of the Related Art

Studies are being conducted on providing services by using mobile vehicles. For example, the convenience of shopping can be improved by dispatching an autonomous mobile vehicle (mobile shop vehicle), which functions as a mobile shop, to the side of users. In addition, the convenience of transportation can be improved by operating omnibuses or coaches capable of performing autonomous traveling.

In cases where operations are conducted by such mobile vehicles, in some embodiments, the demand that will occur is forecasted, and the place of arrangement and sales structure of each mobile vehicle is decided. The forecasting of the demand can be made by using a machine learning algorithm, for example, as disclosed in Patent Literature 1.

### CITATION LIST

### Patent Literature

Patent Literature 1: Japanese Patent Application Laid-open No. 2019-109648

### SUMMARY

A model for performing machine learning can be made to learn by using data (purchase data, etc.) obtained at the time of a service being used in the past. However, in cases where a company does not have a track record of providing services in a new industry, such as when starting a new business in that industry, there will be a problem that sufficient forecasting accuracy cannot be obtained. Although there is also a method of diverting data from other industries, it is not possible to quantitatively show how much reproducibility can be achieved.

The present disclosure has been made in consideration of the problems as referred to above, and has for its object to perform demand forecasting for services that have not yet been provided, with a high degree of accuracy.

The present disclosure in its another aspect provides an information processing method for evaluating teacher data used in a system that forecasts demand for a service by using a forecasting model by machine learning, the method comprising a forecast step of generating demand forecasting data in a second service different from a first service by using the forecasting model that has performed learning by use of first track record data in the first service as teacher data; and a calculation step of calculating a degree of contribution of the first track record data in demand forecasting for the second service based on the result of a comparison made between the demand forecasting data and second track record data in the second service.

The present disclosure in its one aspect provides an information processing apparatus for evaluating teacher data used in a system that forecasts demand for a service by using a forecasting model by machine learning, the apparatus including a control unit configured to execute: generating demand forecasting data in a second service different from a first service by using the forecasting model that has performed learning by use of first track record data in the first service as teacher data; and calculating a degree of contribution of the first track record data in demand forecasting for the second service based on the result of a comparison made between the demand forecasting data and second track record data in the second service.

In addition, another aspect of the present disclosure resides in a program for making a computer execute an information processing method performed by the above-mentioned information processing apparatus, or a computer readable storage medium having the program stored therein in a non-transitory manner.

According to the present disclosure, demand forecasting for services that have not yet been provided can be carried out with a high degree of accuracy.

### BRIEF DESCRIPTION OF THE DRAWINGS

FIG. 1A is a view illustrating an outline of a learning phase in demand forecasting by machine learning.

FIG. 1B is a view illustrating an outline of a forecasting phase in demand forecasting by machine learning.

FIG. 2 is a schematic configuration view of an information processing apparatus according to a first embodiment of the present disclosure.

FIG. 3A is a view explaining data stored in a model storage unit.

FIG. 3B is a view explaining data stored in a data storage unit.

FIG. 4A is a view explaining the data stored in the data storage unit.

FIG. 4B is another view explaining the data stored in the data storage unit.

FIG. 4C is another view explaining the data stored in the data storage unit.

FIG. 5 is an example of an evaluation value generated for each combination of services.

FIG. 6A is a view explaining an outline of building processing of a forecasting model.

FIG. 6B is a flowchart of the building processing of the forecasting model.

FIG. 7A is a view explaining an outline of the processing of forecasting demand.

FIG. 7B is a flowchart of the processing of forecasting demand.

FIG. 8A is a view explaining an outline of the processing of calculating evaluation values.

FIG. 8B is a flowchart of the processing of calculating the evaluation values.

FIG. 9 is a flowchart of processing performed by an evaluation unit in a second embodiment of the present disclosure.

### DESCRIPTION OF THE EMBODIMENTS

There can be considered a mode in which services are provided by a mobile vehicle capable of autonomous driving. For example, a mobile shop vehicle with facilities and equipment for shop operations in the vehicle may be dispatched to a predetermined area to deploy the facilities and equipment to conduct operations. In addition, transportation services for passengers and luggage can also be provided by using mobile vehicles capable of autonomous driving.

The area or point where an autonomous mobile vehicle with a shop function will operate, and the place where an autonomous mobile vehicle having a function of transporting freight and passengers will be dispatched, can be decided on the basis of demand. For example, by performing machine learning by use of data on the feature, weather, time zone (or time of day), etc., of a target area, and data on the demand that has actually occurred (e.g., data indicating sales, and hereinafter referred to as track record data), it is possible to forecast how much demand will occur under certain conditions.

However, in cases where a new service is started as a business and there is no track record of providing the service, it may not be possible to predict demand using machine learning with sufficient accuracy.

A machine learning model may be built based on the actual or track record data generated in an existing service, but in cases where the content of a service, industry or business type is different, expected results may not always be obtained. This is because the time zone and place where the service or goods is sought can vary greatly depending on the content of the service or goods in question.

In order to cope with this, in this embodiment, first, by using a forecasting model that has been learned or trained by use of first track record data in a first service as teacher (training) data, demand forecasting data in a second service different from the first service is generated.

Then, the degree of contribution of the first track record data in the demand forecasting for the second service is calculated based on the result of a comparison made between the demand forecasting data and second track record data in the second service.

In this manner, in a method according to this embodiment, a forecasting model is built by using the track record data obtained at the time of providing a certain service, and demand forecasting in a different service is carried out by using the forecasting model thus built. By making a comparison between the data obtained as a result of this forecasting with actually obtained track record, it can be determined how much the first track record data contributes to the demand forecasting in the second service (in other words, how much accuracy will be obtained in cases where the demand forecasting in the second service is made by the model built by using the track record data generated in the first service).

In addition, in cases where an amount of demand indicated by the demand forecasting data represents a value nearer to an amount of demand indicated by the second track record data, the degree of contribution may also be made higher.

It can be determined that the more similar the forecasted demand is to the demand indicated by the second actual data (i.e., the demand actually generated), the accuracy of the forecasting is higher, i.e., the degree of contribution of the first track record data is higher.

Here, note that a service may be any service that provides value to a consumer, such as a service that provides transportation, a service that provides resources, a service that provides space, a service that sells goods, etc. In this case, if there are differences in the contents of the services to be provided or the goods to be sold, they may be treated as different services. In addition, in cases where the same mobile vehicle is capable of providing different goods, the provision of the individual goods may be treated as different services (i.e., a service to provide goods A, a service to provide goods B, etc.).

Moreover, a plurality of demand forecasting data in the second service may be generated by using a plurality of forecasting models for which the first services are different from each other, and the degree of contribution may be calculated for each of individual combinations of the first services and the second service.

By creating a plurality of combinations of the first services and the second service, it becomes easy to find a combination(s) having a high degree of contribution.

Further, a price of the first track record data, when sold from a first company that has obtained the first track record data to a second company that performs demand forecasting for the second service, may be decided based on the degree of contribution.

The high degree of contribution of the first track record data with respect to the second service means that the value of the first track record data is high for the second company that performs the demand forecasting for the second service. Accordingly, the sales price of the first track record data may be decided based on the degree of contribution.

In addition, a price of the first track record data, when sold from a first company that has obtained the first track record data to a second company that performs demand forecasting for the second service, may be evaluated based on the degree of contribution, and data indicative of an incentive for the first company may be generated, in cases where it is determined that the price of the first track record data is lower than an evaluation price thereof considering the degree of contribution.

In this manner, in cases where the evaluation price considering the degree of contribution is lower than an actual sales price, an incentive to compensate for a price difference may be given. According to such a configuration, activation of data transaction can be attained.

### First Embodiment

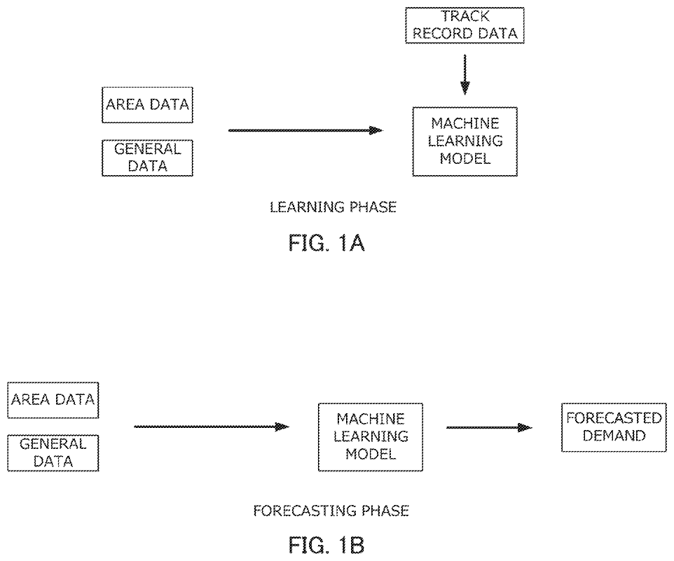

The outline of an information processing apparatus according to a first embodiment will be explained, while referring to FIGS. 1A and 1B. The information processing apparatus according to this embodiment is an apparatus that builds a machine learning model (hereinafter, referred to as a forecasting model) by using as, teacher or training data, the data indicating the track record or actual result of providing goods or services (track record data), and forecasts how much demand for a specific service is expected by using the forecasting model thus built. The track record data is data that represents the provision track record of goods and/or a service, and includes, for example, the content, number of pieces, etc., of the goods and/or service.

The forecasting model uses, as data for forecasting demand, data specific to an area in which goods and/or a service is provided, and general data such as weather, time zone, etc. The former is called area data, whereas the latter is called general data. The area data may be, for example, data in which a target area is divided into meshes and the features in each mesh are represented (for example, the number of facilities and buildings existing in each mesh, their types, and the number of people who can stay in each mesh). The general data may be, for example, the weather, temperature, and target time zone of the target area, the number of people present in the target area, etc. These data are converted into feature values and used as explanatory variables.

When building such a forecasting model, track record data is needed. However, track record data does not always exist in situations where demand forecasting is desired. For example, this is the case where track record data for a certain service (first service) exists, but track record data for a new service (second service) does not exist (or an amount of data is not enough to make forecasting with sufficient accuracy).

In this regard, it seems that demand forecasting in the second service can be made by using a forecasting model learned by the use of the track record data in the first service. However, in many cases, there are significant differences between services in terms of purchasers, locations where services are sought, and time zones when services are sought, so it is difficult to obtain the desired results even if the model is applied directly to the second service.

In order to solve this problem, reference will be made to an information processing apparatus 100 according to the first embodiment.

As a first function, the information processing apparatus 100 builds a model for forecasting demand by using a machine learning algorithm, and performs demand forecasting by use of the model. For example, a machine learning model is built by using the track record data obtained in service A, so that the demand in service A is forecasted by making use of the model thus obtained.

In addition, as a second function, the information processing apparatus 100 determines, based on the forecasted demand, the extent to which the track record data can be diverted between services. For example, by forecasting the demand for service B by use of the machine learning model corresponding to service A and comparing a forecasted result with an actual result, a determination is made as to the level of accuracy that can be obtained in cases where the track record data in service A is diverted to forecast the demand for service B.

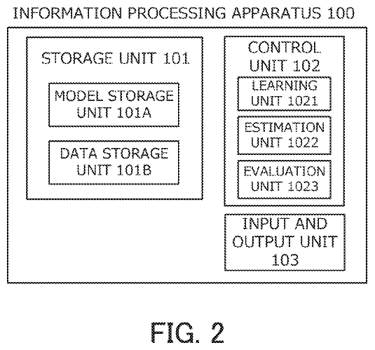

FIG. 2 is a block diagram schematically illustrating an example of the configuration of the information processing apparatus 100.

The information processing apparatus 100 is constructed to include a storage unit 101, a control unit 102, and an input and output unit 103. The information processing apparatus 100 is composed of a general computer having a processor and a memory.

The storage unit 101 is a unit configured to store data necessary for forecasting demand. Specifically, it is composed of including a model storage unit 101A that stores a machine learning model, and a data storage unit 101B that stores data for performing machine learning. Here, note that the storage unit 101 can also store programs to be executed by the control unit 102, which will be described later, and data to be used by the programs. The storage unit 101 is composed of a storage medium such as a RAM, a magnetic disk, a flash memory, or the like.

The model storage unit 101A stores the machine learning model (forecasting model).

The forecasting model is a model that is built by using, as input data, feature values that are the background of demand forecasting, as well as using, as teacher data, feature values obtained by converting the track record data. The information processing apparatus 100 can carry out a phase of learning the forecasting model, and another phase of performing demand forecasting by using this forecasting model.

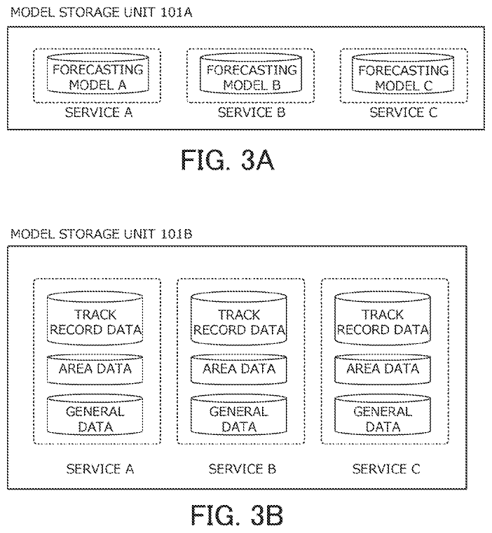

The model storage unit 101A can store a different forecasting model for each of individual target services, as illustrated in FIG. 3A. In the case of the illustrated example, a forecasting model A is a model that has been learned or trained by the track record data generated in service A. In addition, a forecasting model B is a model that has been learned or trained by track record data generated in service B, and a forecasting model C is a model that has been learned or trained by track record data generated in service C.

The data storage unit 101B includes databases that store track record data, area data, and general data. These databases are built by a program(s) of a database management system (DBMS) that is executed by a processor so as to manage the data stored in storage devices. The databases used in this embodiment are relational databases, for example.

The data storage unit 101B can also store different sets of data for each of individual target services, as illustrated in FIG. 3B.

Here, note that in this example, there are three kinds of services, but the number of services is not limited to this.

As data for performing machine learning, there are the track record data, area data, and general data, as mentioned above. These data may be obtained from the outside of the apparatus through a storage medium or network.

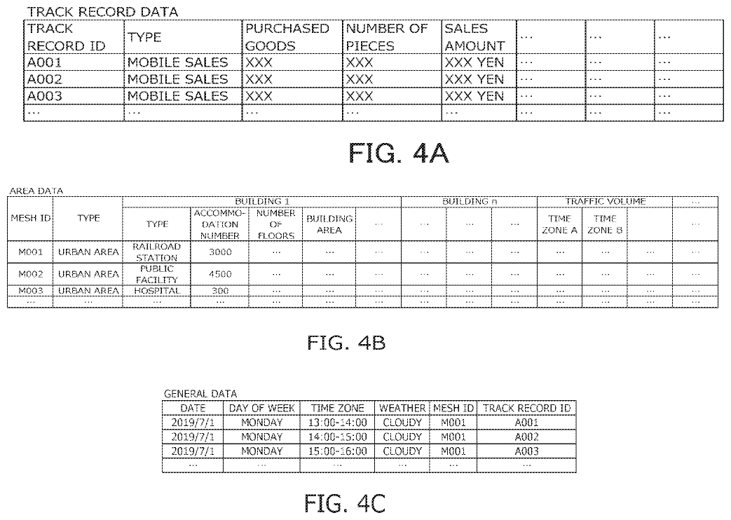

The track record data are data representing track record for goods or services provided. FIG. 4A illustrates an example of the track record data. The track record data are, for example, numerical representations of the content and the number of pieces of goods and/or services, or if a service provides transportation, the number of people, the number of pieces of luggage, the section of transportation, the amount of sales, etc.

The area data are data representing features for a plurality of meshes included in a target area. FIG. 4B illustrates an example of the area data. The area data are, for example, numerical representations of the number and types (e.g., schools, commercial facilities, hospitals, stations, etc.) of facilities and/or buildings in each mesh, and the number of people who can stay in each mesh (e.g., the number of beds if the facility is a hospital, the number of students if the facility is a school, the number of people to be accommodated (capacity) if the facility is an entertainment facility, etc.). In this embodiment, it is assumed that the target area has been divided into a plurality of meshes in advance.

The general data are numerical representations of date, day of the week, time of day, weather, temperature, etc. FIG. 4C illustrates an example of the general data. The general data are data that are not related to the contents of goods or services, but are generally available.

Here, note that in the following explanation, the feature values obtained by converting the track record data are referred to as track record feature values, the feature values obtained by converting the area data are called area feature values, and the feature values obtained by converting the general data are called general feature values.

The control unit 102 is an arithmetic unit that manages the functions of the information processing apparatus 100. The control unit 102 can be achieved by an arithmetic processing unit such as a CPU (Central Processing Unit).

The control unit 102 is composed of including three functional modules: a learning unit 1021, an estimation unit 1022, and an evaluation unit 1023. Each of these functional modules may be achieved by executing programs stored in the storage unit 101 by the CPU.

The learning unit 1021 builds a forecasting model corresponding to a certain service using a data set stored in the data storage unit 101B. For example, the learning unit 1021 converts the track record data, the area data, and the general data corresponding to service A into feature values, and builds the forecasting model A corresponding to service A. The target service can be switched, as mentioned above. For example, the service can be switched to B or C, so that the forecasting model B or C can be built. It is also possible to increase the number of services to be handled according to the data stored.

The estimation unit 1022 performs demand forecasting by using the built forecasting model. Specifically, a forecasting model corresponding to a service to be forecasted is selected, and the feature values on which the forecasting is premised (e.g., the feature values obtained by converting the area data or general data) are input to the forecasting model, so that the size of the demand under a corresponding situation is determined based on the results obtained.

The evaluation unit 1023 makes demand forecasting by applying the built forecasting model to a different service, and evaluates how accurately the forecasting can be made. For example, the demands for services that are different from each other are forecasted by using forecasting models A, B and C built by use of actual data (track record data) corresponding to services A, B and C, respectively. By comparing the forecasted results obtained in this manner with the actual demands generated, it is possible to calculate how useful the track record data generated in certain services are for forecasting the demands in other services.

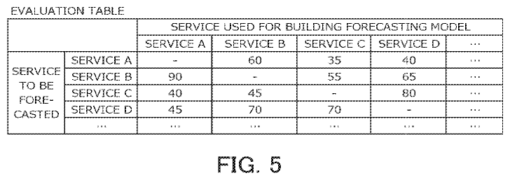

For example, if the result of forecasting the demand for service B by using the forecasting model A built by use of the actual data generated in service A is close to the actual demand generated, it can then be seen that, in forecasting the demand for Service B, the value of actual data (track record data) for service A is high (the degree of contribution is high). The evaluation unit 1023 generates a plurality of such combinations, and gives an evaluation value indicating the level of contribution for each of them. FIG. 5 is an example of an evaluation value generated for each combination of services. It means that the higher the evaluation value, the higher the value of the actual data in that combination. For example, in the illustrated example, it can be seen that the actual data for service A has a high value (evaluation value: 90) in the demand forecasting for service B, and then, the actual data for service D has a high value (evaluation value: 80) in the demand forecasting for service C.

The specific content of the processing to be performed by each functional module will be explained.

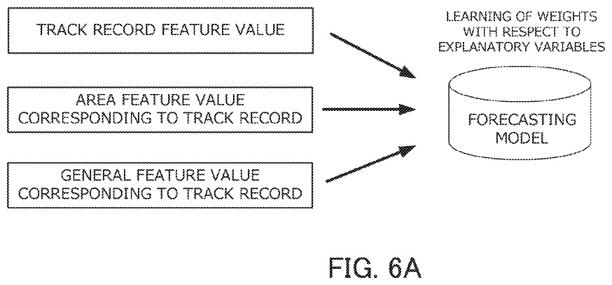

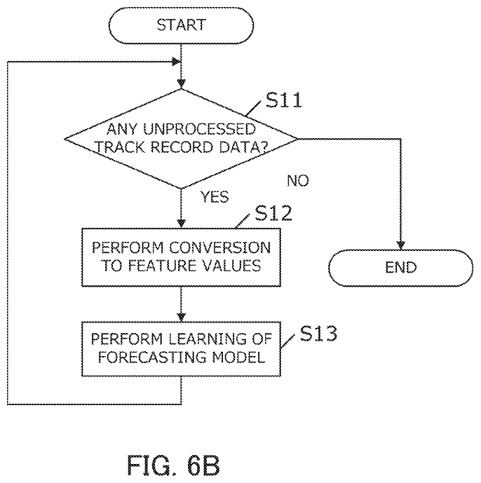

First, a method of building a model to be performed by the learning unit 1021 will be explained. FIG. 6A is a view explaining an outline of the processing of building a forecasting model (learning phase), and FIG. 6B is a flowchart of this processing.

In the learning phase, the learning unit 1021 learns a forecasting model by using a track record feature value(s) as well as an area feature value(s) and a general feature value(s) corresponding to the track record feature value(s). Here, it is assumed that there is the provision track record of a certain service, and its related data (track record data, area data, and general data) have been stored in the data storage unit 101B.

First, the learning unit 1021 determines whether any of the stored track record data has not been used for learning (step 11). Here, in cases where all the track record data have been processed, the processing (or routine) is finished, and otherwise, the processing moves to step S12.

In step S12, among the track record data, a record(s) to be processed is converted into a track record feature value(s) (hereinafter, simply referred to as track record feature values), a record(s) of area data corresponding to the track record is converted into an area feature value(s) (hereinafter, simply referred to as area feature values), and a record(s) of general data corresponding to the track record is converted into a general feature value(s) (hereinafter, simply referred to as general feature values).

Then, in step S13, learning of the forecasting model is performed by using these feature values. The area feature values and the general feature values are explanatory variables, and the track record feature values are objective variables. By repeating this for all the records of the track record data, the weights of the individual explanatory variables with respect to the individual objective variables are updated.

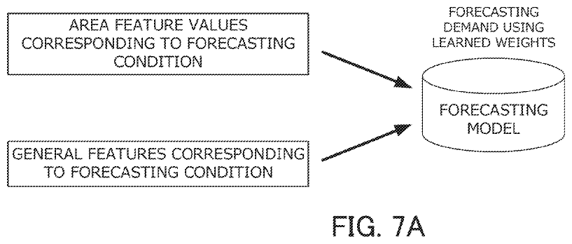

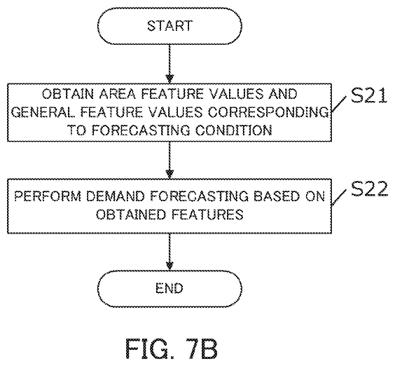

Next, a method for demand forecasting to be performed by the estimation unit 1022 will be described. FIG. 7A is a view explaining an outline of the processing of forecasting demand (forecasting phase), and FIG. 7B is a flowchart of this processing.

In the forecasting phase, the estimation unit 1022 performs demand forecasting by using area feature values and general feature values corresponding to a condition under which the demand is forecasted (forecasting condition). Here, it is assumed that the area feature values and the general feature values corresponding to the forecasting condition have been prepared in advance.

First, the estimation unit 1022 obtains area feature values and general feature values corresponding to the forecasting condition (step S21). The same method can be used for converting data into feature values as when learning them.

Then, the acquired feature values are input to the forecasting model, and the resulting output is acquired as data about the demand to be forecasted (step S22).

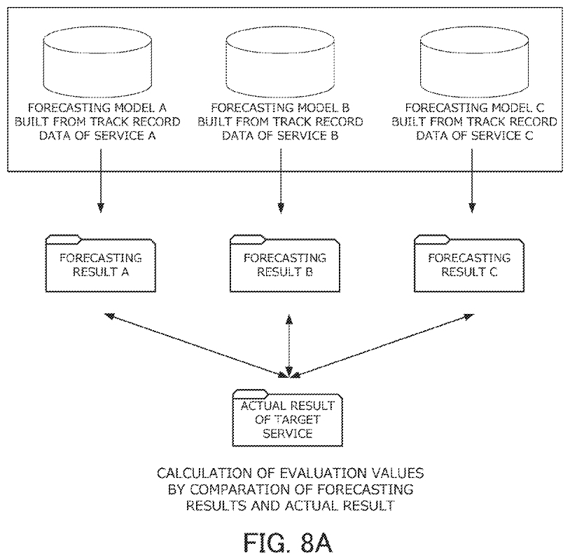

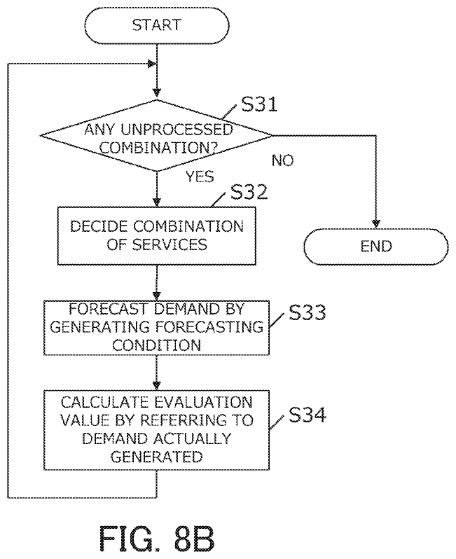

Next, the processing performed by the evaluation unit 1023 will be explained. FIG. 8A is a view explaining an outline of the processing of calculating evaluation values (evaluation phase), and FIG. 8B is a flowchart of this processing.

Here, it is assumed that the track record data of a plurality of services have been stored in the data storage unit 101B, and that a plurality of forecasting models built by using the track record data (forecasting models A to C in an example illustrated in FIG. 8A) have been stored in the model storage unit 101A.

First, the evaluation unit 1023 generates combinations of a plurality of services as illustrated in FIG. 5, and determines whether any combination of unprocessed services exists (step S31). For example, in cases where there are n services, the number of combinations is ₙC₂. Here, in cases where all the combinations have been processed, the processing ends, and otherwise, the processing moves to step S32.

In step S32, a combination of a service associated with a forecasting model (first service) and a service for which demand forecasting is actually performed (second service) is decided. For example, a combination of service A, which is the first service, and service B, which is the second service, is decided. This combination means that demand forecasting for service B is made by use of the forecasting model built using the track record data of service A.

In step S33, a forecasting condition is generated, and the demand forecasting is made by using the forecasting model selected in step S32. For example, the forecasting condition may be generated based on the area data and/or general data stored in the data storage unit 101B. As a result, a forecasting result corresponding to the forecasting model is generated, as illustrated in FIG. 8A.

Subsequently, in step S34, a comparison between the forecasting result thus generated and the demand actually generated (the track record data in the second service) is made, so that an evaluation value indicating the level of accuracy of the forecasting result is calculated. Such a comparison may be made in terms of an amount of service rendered, or a sales amount of money, etc. Here, note that this step may be performed by waiting until the track record data in the second service have been sufficiently accumulated. In other words, in cases where it is determined that the number of track record data in the second service has not been sufficiently accumulated, for example, the number of track record data in the second service is below a predetermined threshold, the processing of step S34 may be postponed for the relevant combinations.

The evaluation value may be, for example, a value that is obtained by normalizing a difference between a value to be obtained originally and a forecasted value to be within a predetermined range. Here, a numerical value from 0 to 100 may be applied as the evaluation value, but any other optional method may be adopted for the calculation of the evaluation value.

The evaluation value calculated here is a value that represents the contribution of the track record data of the first service in the demand forecasting for the second service.

By executing the processing described above, the evaluation unit 1023 can calculate an evaluation value as illustrated in FIG. 5 for each combination of services. The data thus calculated may be provided to a user of the apparatus via the input and output unit 103, or may be transmitted to other devices that use this data.

According to the first embodiment, in cases where demand forecasting for one service, which is a target of demand forecasting, is made by applying track record data in a plurality of other services, it is possible to quantify the level of accuracy that can be obtained. In other words, for services with small amounts of track record data, it is possible to provide indicators for forecasting demand using track record data generated in other services.

Here, note that the forecasting condition to be generated in step S33 may be fixed, but may be changed as appropriate. For example, a plurality of evaluation values may be calculated by using a plurality of forecasting conditions (e.g., by weather, by day of the week, by time of day, etc.), and representative values of these evaluation values may be used as final evaluation values.

In addition, in cases where there is a variation in the evaluation values for each forecasting condition and it is not appropriate to use a single evaluation value, it is possible to output a conditional evaluation value such as “only when the weather is clear”, for example.

### Second Embodiment

In the above-mentioned first embodiment, the evaluation unit 1023 calculates an evaluation value for each combination of the first service and the second service, but instead of calculating an evaluation value, may price the track record data. For example, it is considered that a company or business person (hereinafter, collectively referred to as a company) providing service A may sell track record data to another company providing service B (a company that forecasts demand for service B). As the contribution of this track record data will vary depending on the service to which it is applied, the value of the track record data when bought and sold will also fluctuate. A second embodiment is an embodiment in which on the premise of such a transaction, the evaluation unit 1023 prices the track record data according to an evaluation value thereof.

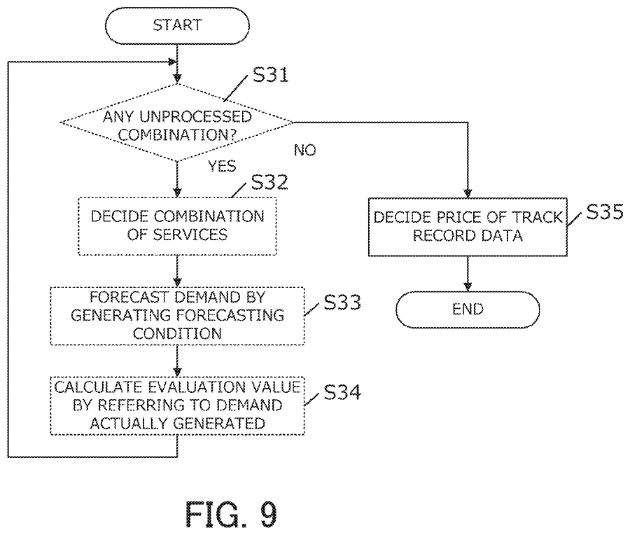

FIG. 9 is a flowchart of the processing to be performed by the evaluation unit 1023 in the second embodiment. In this second embodiment, after the calculation of an evaluation value is completed, then in step S35, a price (evaluation price) of track record data is determined based on the evaluation value.

For example, the evaluation unit 1023 has stored a standard price of the track record data in advance, and corrects the standard price according to the evaluation value. The relationship between the evaluation value and the corrected price may be retained in a formula, etc., or may be retained in a table. For example, if the evaluation value is 100, the price may be a value obtained by multiplying the standard price by 1.00, and if the evaluation value is 50, the price may be a value obtained by multiplying the standard price by 0.50. As a method of correction, there can be adopted an optional correction method.

The corrected price (evaluation price) is stored in a storage device, and made available for trading. The information processing apparatus 100 according to the second embodiment may, for example, retain information about companies that can provide the track record data for each service, and transmit a calculated evaluation price to corresponding companies via a telecommunication line.

According to the second embodiment, the price of buying and selling track record data can be quantified, so it is possible to promote the activation of trading in the track record data.

Here, note that the standard price can be set according to the features of the track record data. For example, it may be possible to separate a step of deciding the standard price according to the quantity and/or granularity of the track record data and a step of making corrections according to the evaluation value from each other. In addition, the standard price may be set based on the actual market price of the track record data.

In addition, information about companies that can provide track record data (hereinafter referred to as “selling companies”) and companies that want to receive the track record data (hereinafter referred to as “buying companies”) may be stored and matched in association with provision conditions. For example, if the calculated evaluation price is equal to or more than the price desired by a selling company but equal to or less than the price desired by a buying company, it may be possible to match these companies and notify each company that a transaction is possible.

Furthermore, other companies that have not yet been registered as selling companies may be encouraged to participate in the sale and purchase by informing them of the calculated price. Moreover, it may also be notified that the data can be sold across industries.

(Modification of the Second Embodiment)

In the second embodiment, the price of track record data is corrected according to the evaluation value, but the price itself may not be corrected and the supplier of the track record data may be given an incentive according to the evaluation value.

In this modification, in step S35, the evaluation unit 1023 first calculates a price (evaluation price) of track record data considering the evaluation value, and then calculates a difference between the evaluation price thus calculated and the standard price (or actual market price) of the track record data set in the system. Then, if the evaluation price is higher than the standard price, the evaluation unit 1023 generates data for providing an incentive corresponding to the difference (incentive data). The incentive data is data that includes the content and amount of money of the incentive, a recipient (i.e., selling company), etc. Such data can be sent to an external device that manages the transaction of the track record data.

According to such a system, an administrator of the system (e.g., a person who manages transactions of the track record data) can encourage the transactions by granting the incentives.

(Other Modifications)

The above-mentioned embodiments are only some examples, and the present disclosure can be modified and implemented as appropriate within the scope not departing from the gist thereof.

For example, the processings, units, devices, etc., described in this disclosure can be implemented in various combinations thereof as long as no technical contradiction arises.

For example, other than those exemplified herein may be used as a basis for calculating an evaluation value. For example, an evaluation value may be calculated by using the number of pieces, the purchase frequency, the amount of sales, the number of purchasers, and/or the identifier, of goods or service that has been purchased in a target period of time, or a value obtained by combining all or some of these. An evaluation value may be calculated in any way that represents the proximity of the forecasted demand to the actual demand that has been generated.

Moreover, the processing described as being performed by a single unit or device may be shared and carried out by a plurality of units or devices. Alternatively, the processing described as being performed by different units or devices may be performed by a single unit or device. In a computer system, the hardware configuration (server configuration) by which each function is realized can be flexibly changed.

The present disclosure can also be achieved by supplying to a computer a computer program that implements the functions described in the above-mentioned embodiments, and by reading out and executing the program by one or more processors of this computer. Such a computer program may be provided to the computer by a non-transitory computer readable storage medium that can be connected to a system bus of the computer, or may be provided to the computer through a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, any type of medium suitable for storing electronic commands.

What is claimed is:

1. An information processing method for evaluating teacher data used in a system that forecasts demand for a service by using a forecasting model by machine learning, the method comprising:
a forecast step of generating demand forecasting data in a second service different from a first service by using the forecasting model that has performed learning by use of first track record data in the first service as teacher data; and
a calculation step of calculating a degree of contribution of the first track record data in demand forecasting for the second service based on the result of a comparison made between the demand forecasting data and second track record data in the second service.

2. The information processing method according to claim 1, wherein
in the calculation step, in cases where an amount of demand indicated by the demand forecasting data represents a value nearer to an amount of demand indicated by the second track record data, the degree of contribution is made higher.

3. The information processing method according to claim 1, wherein
in the forecast step, a plurality of demand forecasting data in the second service are generated by using a plurality of forecasting models for which the first services are different from each other; and
in the calculation step, the degree of contribution is calculated for each of individual combinations of the first services and the second service.

4. The information processing method according to claim 1, further comprising:
a decision step of deciding a price of the first track record data, when sold from a first company that has obtained the first track record data to a second company that performs demand forecasting for the second service, based on the degree of contribution.

5. The information processing method according to claim 1, further comprising:
a decision step of evaluating a price of the first track record data, when sold from a first company that has obtained the first track record data to a second company that performs demand forecasting for the second service, based on the degree of contribution, and generating data indicative of an incentive for the first company in cases where it is determined that the price of the first track record data is lower than an evaluation price thereof considering the degree of contribution.

6. An information processing apparatus for evaluating teacher data used in a system that forecasts demand for a service by using a forecasting model by machine learning, the apparatus including a control unit configured to execute:
generating demand forecasting data in a second service different from a first service by using the forecasting model that has performed learning by use of first track record data in the first service as teacher data; and
calculating a degree of contribution of the first track record data in demand forecasting for the second service based on the result of a comparison made between the demand forecasting data and second track record data in the second service.
